(19) United States
(12) Patent Application Publication
(10) Pub. No.: US 2026/0296186 A1
(43) Pub. Date: Oct. 1, 2026

(54) DISPLAY CONTROL SYSTEM PREVENTING SPOOFING OF VEHICLE AMBIENT LIGHT LEVEL

(71) Applicant: GM GLOBAL TECHNOLOGY OPERATIONS LLC, Detroit, MI (US)

(72) Inventors: Joseph F. Szczerba, Grand Blanc, MI (US); Daniel S. Glaser, Novi, MI (US); John Radoicic, Sterling Heights, MI (US); David Bongiorno, Sterling Heights, MI (US); Mohammad Muttaqeen, Warren, MI (US)

(21) Appl. No.: 19/094,105

(22) Filed: Mar. 28, 2025

(51) Int. Cl. B60K 35/22; B60K 35/81; G09G 5/10

(52) U.S. Cl. CPC B60K 35/22; B60K 35/81; G09G 5/10; G09G 2320/0626

(57) ABSTRACT

A vehicle includes a global positioning system to determine a location of the vehicle. An ambient light sensor generates a measured ambient light level in the vehicle. A passenger display control module sets a brightness level of a passenger display in response the measured ambient light level, selectively detects ambient light spoofing, and overrides the brightness level of the passenger display in response to detection of the ambient light spoofing. The passenger display control module selecta a viewing mode of the passenger display to one of a private viewing mode and a shared viewing mode. The passenger display control module selectively overrides the brightness level when the viewing mode is set to the private viewing mode and the ambient light spoofing is detected and does not selectively override the brightness level when the viewing mode is set to the shared viewing mode.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle displays, and more particularly to a control system for a vehicle display that prevents spoofing of vehicle ambient light level measured by ambient light sensor.

Ambient light sensors are commonly used in vehicles to automatically adjust the brightness of displays, such as infotainment screens, passenger displays, and instrument panels, based on ambient light level in the passenger compartment. This improves visibility and reduces driver distraction. During the daytime, the ambient light level is high and the brightness of the displays is increased to facilitate viewing. At nighttime, the ambient light level is low and the brightness is reduced.

### SUMMARY

A vehicle includes a global positioning system configured to determine a location of the vehicle. An ambient light sensor is configured to generate a measured ambient light level in the vehicle. A passenger display control module is configured to set a brightness level of a passenger display in response the measured ambient light level, selectively detect ambient light spoofing, and override the brightness level of the passenger display in response to detection of the ambient light spoofing.

In other features, the passenger display control module is configured to select a viewing mode of the passenger display to one of a private viewing mode and a shared viewing mode. The passenger display control module is configured to selectively override the brightness level when the viewing mode is set to the private viewing mode and the ambient light spoofing is detected and to not selectively override the brightness level when the viewing mode is set to the shared viewing mode. The passenger display control module includes a solar position determining module configured to estimate a position of the sun relative to the location of the vehicle, a date, and a time of day. The passenger display control module includes an ambient light estimating module configured to estimate an ambient light level in the vehicle in response to the position of the sun.

In other features, the passenger display control module is configured to selectively override the brightness level of the passenger display when a difference between the measured ambient light level and the estimated ambient light level is greater than a predetermined threshold. The passenger display control module selectively overrides the brightness level of the passenger display when the vehicle is driving, the measured ambient light level corresponds to daytime, and the estimated ambient light level corresponds to nighttime.

In other features, the time of day and the position of the sun are determined locally in the vehicle. At least one of the time of day and the position of the sun received by the vehicle from a remote server. The ambient light estimating module is configured to estimate the ambient light level further in response to at least one of weather, terrain, and local artificial light at the location of the vehicle.

A vehicle includes a global positioning system configured to determine a location of the vehicle. An ambient light sensor is configured to generate a measured ambient light level in the vehicle. A passenger display control module includes a solar position determining module configured to determine a position of the sun relative to the location of the vehicle, a date, and a time of day, and an ambient light estimating module configured to estimate an ambient light level in response to the position of the sun, a brightness control module configured to set a brightness level of the passenger display in response the ambient light level, when the brightness level of the passenger display corresponds to daytime, selectively detect ambient light spoofing based on a difference between the measured ambient light level and the estimated ambient light level, selectively override the brightness level of the passenger display in response to detecting the ambient light spoofing.

In other features, the passenger display control module is configured to set a viewing mode of the passenger display to one of a private viewing mode and a shared viewing mode. The passenger display control module is configured to select the viewing mode in response to a selected type of content output to the passenger display. The brightness control module is configured to selectively override the brightness level when the viewing mode is set to the private viewing mode and the ambient light spoofing is detected and to not selectively override the brightness level when the viewing mode is set to the shared viewing mode.

In other features, the passenger display control module is configured to selectively override the brightness level of the passenger display when a difference between the measured ambient light level and the estimated ambient light level is greater than a predetermined threshold. The passenger display control module selectively overrides the brightness level of the passenger display when the vehicle is driving, the measured ambient light level corresponds to daytime, and the estimated ambient light level corresponds to nighttime. The time of day and the position of the sun are determined locally in the vehicle.

In other features, at least one of the time of day and the position of the sun received by the vehicle from a remote server. The ambient light estimating module is configured to estimate the ambient light level further in response to at least one of weather, terrain, and local artificial lighting at the location of the vehicle.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIGS. 1 and 2 are plan views of examples of a passenger compartment of a vehicle including a=passenger display operating in a narrow angle or privacy mode and a wide angle or sharing mode, respectively;

FIGS. 3 and 4 illustrate an example of passenger and driver views of the passenger display under dark conditions without and with ambient light spoofing, respectively;

FIG. 5 is a functional block diagram of an example of a vehicle including a display control system configured to prevent ambient light spoofing according to the present disclosure;

FIG. 6 illustrates an example of a position of the sun relative to a location of the vehicle on the ground;

FIG. 7 is an example of a sun chart for a predetermined northern latitude; and

FIG. 8 is a flowchart of an example of a method for operating a display controller to prevent ambient light spoofing according to the present disclosure.

In the drawings, reference numbers may be reused to identify similar and/or identical elements.

### DETAILED DESCRIPTION

Ambient light sensors are commonly used in vehicles to automatically adjust the brightness of displays, such as infotainment screens, passenger displays, and instrument panels, based on ambient light level to improve visibility and reduce driver distraction. However, the ambient light sensors can be susceptible to spoofing by an occupant of the vehicle. One form of spoofing involves using an artificial light source, such as a flashlight, to intentionally or accidentally increase an ambient light level measured by the ambient light sensor to trigger an increase in the brightness of the passenger display. This situation can be problematic when the increased brightness allows the driver to be distracted by viewing the passenger display. The brightness of the infotainments screen and/or instrument panel may also be a distraction.

The present disclosure mitigates ambient light sensor spoofing by determining estimated ambient light level, measuring the ambient light level using an ambient light sensor, and comparing the estimated ambient light level to the measured ambient light level.

The estimated ambient light level is determined based on a geolocation of the vehicle and a position of the sun based on the geolocation, date, and time. When the measured light level is inconsistent with the estimated ambient light level based on the position of the sun, the display control system overrides the ambient light sensor reading to reduce the brightness of the passenger display at night and prevent driver distraction. When the measured ambient light level is consistent with the estimated ambient light level, the measured ambient light level is accepted and the brightness of a display is adjusted based thereon.

Referring now to FIGS. 1 to 4, viewing modes of a passenger display 10 are shown. The passenger display 10 is typically arranged on a dashboard 12 facing the passenger seated in a passenger seat 14, although other locations can be used. A driver is seated in a driver seat 16 adjacent to the passenger seat 14. In FIG. 1, the passenger display 10 is operated in a private viewing mode during which the passenger display 10 has a narrow angle of view.

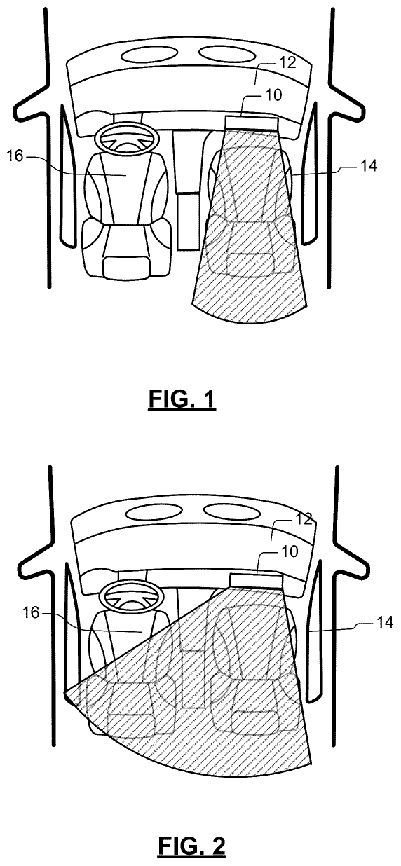

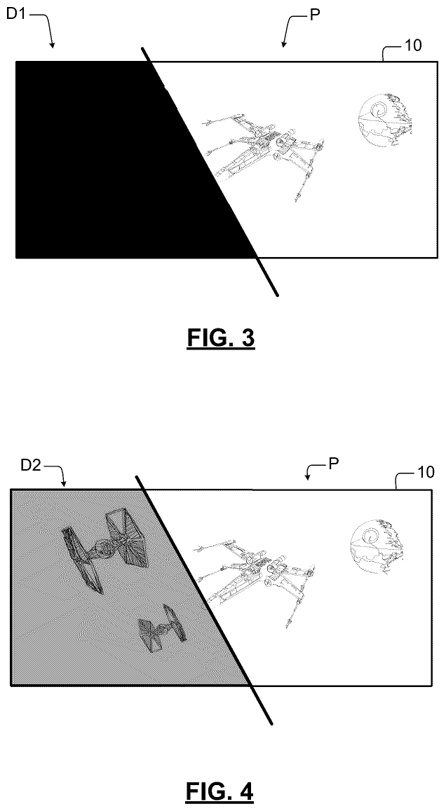

In FIG. 2, the passenger display 10 is operated in a shared viewing mode during which the passenger display 10 has a wide angle of view that can be seen by the driver. In some examples, the display control system automatically controls an active filter to select between shared and private viewing depending upon the selected content, a driving status of the vehicle (parked or driving), and/or other criteria. During a trip, the passenger of the vehicle can view content that is not appropriate for the driver to be viewing. For example, certain kinds of content such as videos, video games, movies, etc. may be a prolonged distraction for the driver.

A display control system according to the present disclosure also controls the brightness of the passenger display 10 based upon the amount of ambient light sensed by an ambient light sensor (FIG. 5). If there is a lot of ambient light, the display control system increases the brightness of the passenger display 10 so that it can be viewed at the higher ambient light level. If there is low ambient light such as during nighttime, the display control system decreases the brightness of the passenger display. Normally, the narrow angle viewing mode of the passenger display 10 is sufficient to prevent the driver from viewing and being distracted by the content output to the passenger display 10.

During low ambient light conditions, the brightness of the passenger display 10 is normally decreased to a lower setting since the passenger display 10 can be seen more easily due to the lower level of ambient light. However, if an occupant of the vehicle shines a light on the ambient light sensor, the brightness of the passenger display 10 is increased to a daylight brightness level. The purpose of shining light onto the ambient light sensor is to trick the display control system into increasing the brightness so that the driver can also view the content on the passenger display 10.

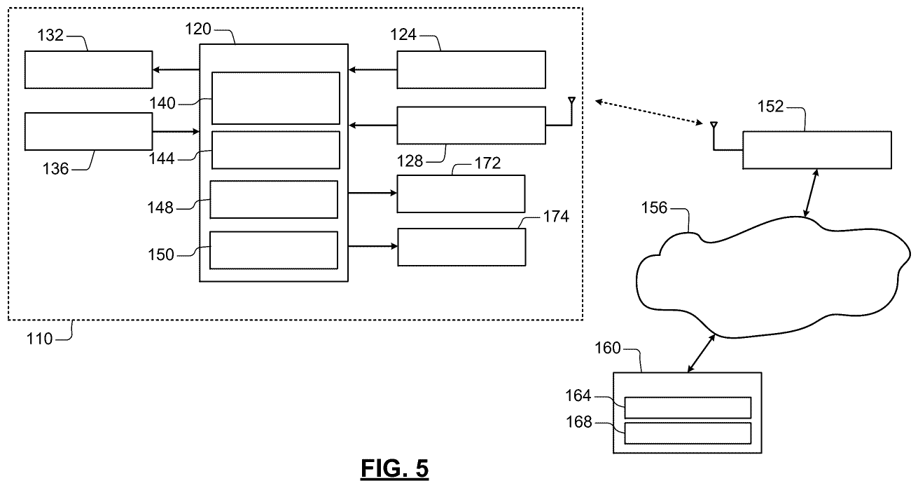

In FIG. 3, the passenger display 10 is shown in the narrow angle viewing mode that does not limit a passenger view P while using the active filter to prevent viewing by a driver D1. In FIG. 4, the passenger display 10 is shown under low light conditions (e.g., nighttime) after ambient light spoofing and with the narrow angle viewing mode enabled. Under low light conditions (e.g., nighttime), a driver D2 can view content displayed on the passenger display 10 (e.g., the driver view D2 is partially obscured by the active filter).

Referring now to FIG. 5, a vehicle 110 includes a display controller 120, a global positioning system (GPS)/compass 124, and a telematics system 128. The GPS/compass 124 is configured to determine a position and heading of the vehicle 110. A passenger display 132 has controllable brightness level and a variable display mode (including a narrow angle viewing mode for private viewing and a wide angle viewing mode for shared viewing). An ambient light sensor 136 is configured to sense ambient light levels in a passenger compartment.

The display controller 120 includes a solar position determining module 140, an ambient light estimating module 144, a brightness control module 148, and a map module 150. The solar position determining module 140 determines the position of the sun relative to the location and/or heading of the vehicle, the date, the time, and/or other information.

The ambient light estimating module 144 is configured to calculate an estimated ambient light level in the vehicle 110 based on the position of the sun. The brightness control module 148 is configured to output content to the passenger display (e.g., selected by the passenger) and to switch the passenger display between a narrow angle mode (or private viewing mode) and wide angle mode (or shared viewing mode) based on various parameters such as display content, whether the vehicle 110 is driving, or other criteria. The map module 150 is configured to store terrain maps, local sun path charts, etc. In some examples, the vehicle 110 may be located adjacent to a mountain or other obstruction that may impact the ambient light level in the vehicle 110.

The telematics system 128 is configured to wirelessly communicate with a remote server 152 using a cellular, satellite, or other wireless network. The remote server 152 communicates with a distributed communication network 156 such as the Internet. One or more servers 160 receive requests for data and are configured to send sun position data, sun path charts, weather data 164, and/or map data 168.

The vehicle 110 may include another display 172 such as a display on the instrument panel or other location, a haptic device 174, and/or a speaker (not shown) to provide a visual alert, a haptic alert, or an audible alert that ambient light spoofing is detected.

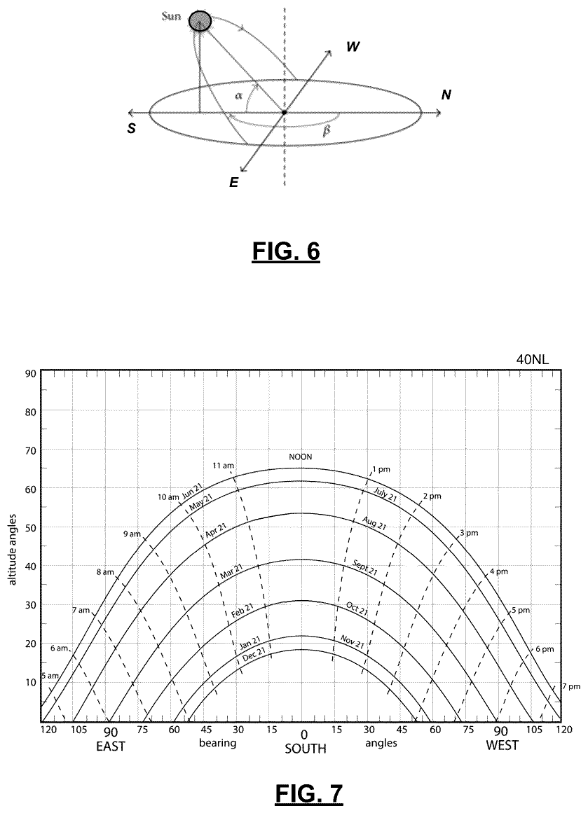

Referring now to FIGS. 6 and 7, the location and heading of the vehicle and the corresponding sun position are used to estimate the ambient light level. In FIG. 6, an altitude angle α and rotation angle β of the sun are shown for a location on earth. The altitude angle α and rotation angle β affect the ambient light level in the vehicle. In FIG. 7, a sun path chart for a given latitude is shown. In some examples, the sun path charts and terrain maps are stored in the map module 150 and/or retrieved from a remote server as needed.

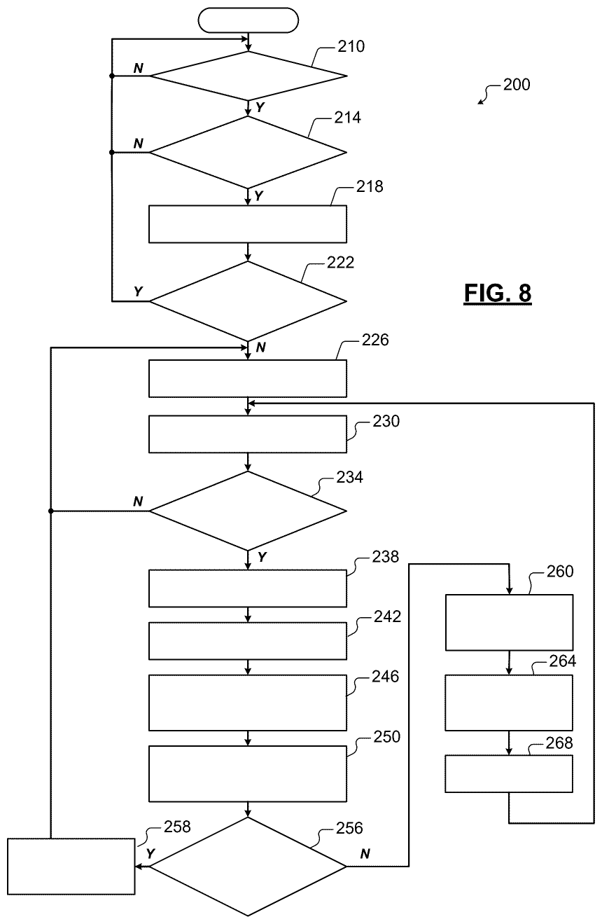

Referring now to FIG. 8, a method for controlling a passenger display according to the present disclosure is shown. At 210, the method determines whether the vehicle is driving. In some examples, the method also determines the time of day and/or date from a local source (onboard the vehicle) or a remote source (to prevent manipulation).

If 210 is true, the method determines whether an application is activated to prevent wide angle viewing and outputs content to the passenger display. If 214 is true, the method outputs in wide angle mode. At 222, the method determines whether the application is acceptable for driver viewing while the vehicle is in motion. If 222 is true, the method returns to 210.

If 222 is false, the method continues at 226 and applies an active filter to block the driver's view of the passenger display. At 230, the method reads the ambient light sensor at predetermined intervals. At 234, the method determines whether the measured ambient light level corresponds to daytime (high ambient light level) or nighttime (low ambient light level). At 238, the method determines the GPS location of the vehicle, date, and time of day. In some examples, time of day can be determined locally or remotely from a remote server or other trusted source to prevent manipulation of a local clock.

At 242, the method determines the position of the sun relative the vehicle. At 246, the method determines the weather and/or cloud conditions at the vehicle location. At 250, the method optionally uses a 3D terrain map (in addition to the position of the sun, weather, and cloud conditions) to determine the estimated ambient light level.

At 256, the method determines whether the estimated ambient light level corresponds to the sensed ambient light level. If true, the measured ambient light level is set to true, and the method returns to 226. If 256 is false, the method sets the measured ambient light level to false at 260. At 264, the ambient light level status is set to nighttime at 264 and the passenger display is dimmed at 268. As a result, the driver will be unable to view the content output to the passenger display, which reduces the risk of glare or distraction caused by the driver viewing the passenger display.

In some examples, the solar position determining module 140 determines the position of the sun in response to the vehicle location, date, and time. In some examples, the solar position determining module 140 retrieves the sun position from a remote server by sending a request with the vehicle location, date, and time. In other examples, the solar position determining module 140 determines the solar position locally using on-board data such as sun charts or a table outputting sun angle or estimated ambient light level as a function of vehicle location, time of day, and date.

If used as a local application, one or more steps can be taken to minimize local storage requirements. For example, latitude and longitude resolution can be limited since lower resolution can still provide sufficient accuracy for determining the position of the sun. In other examples, data for areas over bodies of water can be eliminated since vehicles typically operate on land (in other words, data for oceans and large lakes can be excluded). In other examples, time resolution can be limited (e.g., using minutes instead of seconds for time resolution can reduce data size without significantly impacting accuracy for this application). In other examples, output data can be reduced to the sun's angle relative to the horizon.

The ambient light estimating module 144 determines the estimated ambient light level in response to the position of the sun. In some examples, a transfer function or lookup table converts the sun's angle relative to the horizon into an ambient light level (e.g., lux).

In some examples, the solar position determining module 140 can select daytime or nighttime lighting conditions in response to sun angle. For example, if the sun angle is less than a predetermined angle (e.g., 18 degrees), the ambient light level should be nighttime. If the sun angle is greater than predetermined angle, the ambient light level should be daytime. However, other values for the predetermined angle can be used.

In some examples, spoof mitigation is limited to certain situations to reduce processing load. For example, spoof mitigation can be limited to nighttime when driver visibility of the content on the passenger display is possible. In other examples, spoof mitigation can be performed when an ambient light level change rate is greater than a predetermined rate (e.g., a predetermined change within a predetermined period). In other examples, spoof mitigation is performed when the ambient light level change rate increases by the predetermined rate and remains high for a predetermined period (e.g., longer than 5 seconds).

For example, shining a flashlight (e.g., usually greater than 250, 500, or more lux) on the ambient light sensor increases the measured ambient light level well over the acceptable brightness of city lights at night (e.g., approximately 15 lux).

In some examples, the location of the vehicle may be analyzed to determine whether local artificial lighting may be impacting the ambient light measurement. For example, if the vehicle is located in a garage or parking structure at night, the determination of the estimated ambient light level may be modified because the ambient light sensor will read a higher ambient light level due to artificial indoor lighting. For this type of location, the higher measured ambient light level reading may be accepted as true or valid. In another example, if a location has streetlamps that illuminate the location at night, rapid fluctuations in light levels may occur. The ambient light estimating module 144 may ignore the short bursts of increased ambient light and use a default nighttime brightness value to avoid erratic display adjustments.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML 5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A vehicle comprising:
a global positioning system configured to determine a location of the vehicle;
an ambient light sensor configured to generate a measured ambient light level in the vehicle;
a passenger display;
a passenger display control module configured to:
set a brightness level of the passenger display in response the measured ambient light level;
selectively detect ambient light spoofing; and
override the brightness level of the passenger display in response to detection of the ambient light spoofing.

2. The vehicle of claim 1, wherein the passenger display control module is configured to select a viewing mode of the passenger display to one of a private viewing mode and a shared viewing mode.

3. The vehicle of claim 2, wherein the passenger display control module is configured to selectively override the brightness level when the viewing mode is set to the private viewing mode and the ambient light spoofing is detected and to not selectively override the brightness level when the viewing mode is set to the shared viewing mode.

4. The vehicle of claim 1, wherein the passenger display control module includes a solar position determining module configured to estimate a position of the sun relative to the location of the vehicle, a date, and a time of day.

5. The vehicle of claim 4, wherein the passenger display control module includes an ambient light estimating module configured to estimate an ambient light level in the vehicle in response to the position of the sun.

6. The vehicle of claim 5, wherein the passenger display control module is configured to selectively override the brightness level of the passenger display when a difference between the measured ambient light level and the estimated ambient light level is greater than a predetermined threshold.

7. The vehicle of claim 5, wherein the passenger display control module selectively overrides the brightness level of the passenger display when the vehicle is driving, the measured ambient light level corresponds to daytime, and the estimated ambient light level corresponds to nighttime.

8. The vehicle of claim 4, wherein the time of day and the position of the sun are determined locally in the vehicle.

9. The vehicle of claim 4, wherein at least one of the time of day and the position of the sun received by the vehicle from a remote server.

10. The vehicle of claim 5, wherein the ambient light estimating module is configured to estimate the ambient light level further in response to at least one of weather, terrain, and local artificial light at the location of the vehicle.

11. A vehicle comprising:
a global positioning system configured to determine a location of the vehicle;
an ambient light sensor configured to generate a measured ambient light level in the vehicle;
a passenger display;
a passenger display control module including:
a solar position determining module configured to determine a position of the sun relative to the location of the vehicle, a date, and a time of day;
an ambient light estimating module configured to estimate an ambient light level in response to the position of the sun;
a brightness control module configured to:
set a brightness level of the passenger display in response the ambient light level;
when the brightness level of the passenger display corresponds to daytime, selectively detect ambient light spoofing based on a difference between the measured ambient light level and the estimated ambient light level; and
selectively override the brightness level of the passenger display in response to detecting the ambient light spoofing.

12. The vehicle of claim 11, wherein the passenger display control module is configured to set a viewing mode of the passenger display to one of a private viewing mode and a shared viewing mode.

13. The vehicle of claim 12, wherein the passenger display control module is configured to select the viewing mode in response to a selected type of content output to the passenger display.

14. The vehicle of claim 12, wherein the brightness control module is configured to selectively override the brightness level when the viewing mode is set to the private viewing mode and the ambient light spoofing is detected and to not selectively override the brightness level when the viewing mode is set to the shared viewing mode.

15. The vehicle of claim 11, wherein the passenger display control module is configured to selectively override the brightness level of the passenger display when a difference between the measured ambient light level and the estimated ambient light level is greater than a predetermined threshold.

16. The vehicle of claim 11, wherein the passenger display control module selectively overrides the brightness level of the passenger display when the vehicle is driving, the measured ambient light level corresponds to daytime, and the estimated ambient light level corresponds to nighttime.

17. The vehicle of claim 11, wherein the time of day and the position of the sun are determined locally in the vehicle.

18. The vehicle of claim 11, wherein at least one of the time of day and the position of the sun received by the vehicle from a remote server.

19. The vehicle of claim 11, wherein the ambient light estimating module is configured to estimate the ambient light level further in response to at least one of weather, terrain, and local artificial lighting at the location of the vehicle.

20. A vehicle comprising:
a global positioning system configured to determine a location of the vehicle;
an ambient light sensor configured to generate a measured ambient light level in the vehicle;
a passenger display;
a passenger display control module including:
a solar position determining module configured to determine a position of the sun relative to the location of the vehicle, a date, and a time of day;
an ambient light estimating module configured to estimate an ambient light level in response to the position of the sun;
a brightness control module configured to:
set a brightness level of the passenger display in response the ambient light level;
when the brightness level of the passenger display corresponds to daytime, selectively detect ambient light spoofing based on a difference between the measured ambient light level and the estimated ambient light level; and
selectively override the brightness level of the passenger display in response to detecting the ambient light spoofing,
wherein the passenger display control module is configured to set a viewing mode of the passenger display to one of a private viewing mode and a shared viewing mode, and
wherein the passenger display control module is configured to select the viewing mode in response to a selected type of content output to the passenger display.
